(19) United States
(12) Patent Application Publication
(10) Pub. No.: US 2002/0186481 A1
(43) Pub. Date: Dec. 12, 2002

(54) Lateral-view mirror assembly for a vehicle

(76) Inventor: Lowell Martinson, Phoenix, AZ (US)

Correspondence Address: WEISS & MOY PC, 4204 NORTH BROWN AVENUE, SCOTTSDALE, AZ, 85251, US

(21) Appl. No.: 09/875,212

(22) Filed: Jun. 7, 2001

(51) Int. Cl. G02B 5/08; G02B 7/182

(52) U.S. Cl. 359/855; 359/838; 359/857

(57) ABSTRACT

A lateral-view mirror assembly for a vehicle capable of providing a driver of a vehicle with the ability to view objects positioned lateral to a rear portion of the vehicle by looking at a reflection of the objects reflected from the lateral-view mirror to the driver. One embodiment requires the use of a rear-view mirror, while another requires the use of a side-view mirror. The lateral-view mirror can be coupled to the vehicle during the manufacturing stage or after manufacture with an adhesive.

### FIELD OF THE INVENTION

This invention relates generally to mirrors for vehicles designed to aid a driver in identifying objects and, more specifically, to a lateral-view mirror assembly for a vehicle dimensioned to allow a driver to view objects positioned lateral to a rear portion of the vehicle.

### BACKGROUND OF THE INVENTION

Driving a car or other vehicle safely requires the driver to constantly be able to see other vehicles, objects and pedestrians. This is often difficult since a car has many blind-spots, and the driver generally is facing forward with limited ability to turn around and view surrounding areas. One situation where a driver's limited field of vision presents an especially acute problem is when pulling out of a parking space. When a driver needs to back out of a parking space in which he or she is parked face-forward between two other vehicles, especially when those vehicles are large in size, the driver has limited or no ability to see laterally to either side of the rear portion of his or her vehicle to determine if there are pedestrians or other vehicles about to cross into his or her path. This problem has become particularly acute since the mid-1990's, with the increase in popularity of relatively large profile sports utility vehicles.

Often, drivers in this situation simply back out slowly in an attempt to alert pedestrians and other cars of the vehicle's presence. This method is fraught with danger. It is often the case that pedestrians walking through a parking lot simply do not see a car as it backs out. The same can be true for another vehicle or a bike that might be passing quickly behind the driver's vehicle as he or she backs out. In order to be certain that a pedestrian or vehicle is not approaching before backing out in a blind manner, the driver must be able to see laterally from a rear portion of the driver's vehicle.

Thus, a need existed for a lateral-view mirror assembly for a vehicle dimensioned to allow a driver to view people, vehicles and other objects positioned lateral to a rear portion of the vehicle by looking at a reflection of those objects through a lateral-view mirror, and without the need to first undertake a blind backing up maneuver. Such an assembly should permit the driver to view lateral objects through an existing vehicle mirror, such as a side view mirror or a rear view mirror. The lateral view mirror assembly should also be able to be fitted to an existing vehicle, and should be able to accommodate the different shapes of vehicles and obstructions in the rear window. The present invention satisfies these needs and provides other, related, advantages.

### SUMMARY OF THE INVENTION

An object of the present invention is to provide a lateral-view mirror assembly for a vehicle capable of providing a lateral-view mirror dimensioned to allow a driver to view objects positioned lateral to a rear portion of the vehicle by looking at a reflection of such objects through the lateral-view mirror.

It is a further object of the present invention to provide a lateral-view mirror assembly for a vehicle capable of providing a side-view mirror used in combination with a lateral-view mirror positioned in a line of sight with the side-view mirror and dimensioned to allow a driver to view objects positioned lateral to a rear portion of the vehicle by looking at a reflection of the objects reflected from the lateral-view mirror to the side-view mirror to the driver.

It is still a further object of the present invention to provide a lateral-view mirror assembly for a vehicle capable of providing a rear-view mirror and at least one lateral-view mirror coupled to a center portion of a top surface of a rear portion of the vehicle and positioned in a line of sight with the rear-view mirror and dimensioned to allow a driver to view objects positioned lateral to a rear portion of the vehicle by looking at a reflection of the objects reflected from the lateral-view mirror to the rear-view mirror to the driver.

It is yet a further object of the present invention to provide a lateral-view mirror assembly that may be adapted to vehicles having different-shaped rear portions.

It is still a further object of the present invention to provide a lateral-view mirror assembly that may be adapted to vehicles having partially obstructed rear windows.

### BRIEF DESCRIPTION OF THE PREFERRED EMBODIMENTS

In accordance with one embodiment of the present invention, a lateral-view mirror assembly for a vehicle is disclosed, comprising, in combination: a vehicle; and at least one lateral-view mirror coupled to one of a rear portion and a rear window of the vehicle in line of sight with at least one of a side mirror of the vehicle and a rear-view mirror of the vehicle and dimensioned to allow a driver to view objects positioned lateral to a rear portion of the vehicle by looking at one of the side mirror and the rear-view mirror and seeing a reflection of the objects through the lateral-view mirror.

In accordance with another embodiment of the present invention, a lateral-view mirror assembly for a vehicle is disclosed, comprising, in combination: a vehicle; and at least one lateral-view mirror coupled to a side rear portion of the vehicle in line of sight with a side mirror of the vehicle and dimensioned to allow a driver to view objects positioned lateral to a rear portion of the vehicle by looking at the side mirror and seeing a reflection of the objects through the lateral-view mirror.

In accordance with another embodiment of the present invention, a lateral-view mirror assembly for a vehicle is disclosed, comprising, in combination: a vehicle; and at least one lateral-view mirror coupled to a top rear portion of the vehicle in line of sight with a rear-view mirror of the vehicle and dimensioned to allow a driver to view objects positioned lateral to a rear portion of the vehicle by looking at the rear-view mirror and seeing a reflection of the objects through the lateral-view mirror.

A lateral-view assembly for a vehicle comprising, in combination: a vehicle; and means for capturing an image of an area rearward of and lateral to the vehicle and displaying the image to a driver of the vehicle.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of an embodiment of the lateral-view mirror assembly of the present invention, showing a driver's side lateral-view mirror.

FIG. 2 is a top view of another embodiment of the lateral-view mirror assembly of the present invention, showing the uses of driver and passenger side-view mirrors to view areas lateral to both sides of a rear portion of the vehicle.

FIG. 3 is a perspective view of a lateral-view mirror of the present invention.

FIG. 4 is a side view of the lateral-view mirror of FIG. 3.

FIG. 5 is a bottom view of the lateral-view mirror of FIG. 3, showing two adhesive squares.

FIG. 6 is a perspective view of the lateral-view mirror assembly of FIG. 2, showing the driver and the mirror assembly without the vehicle to illustrate how the driver views objects lateral to a rear portion of a vehicle.

FIG. 6A is a perspective view of the substantially flat mirror coupled to a portion of the passenger's side side-view mirror and positioned in a line of sight with the passenger's side lateral-view mirror.

FIG. 7 is a perspective view of another embodiment of the lateral-view mirror assembly of the present invention, showing a rear-view mirror in phantom and a bidirectional lateral-view mirror positioned in a line of sight with the rear-view mirror and dimensioned to allow a driver to view objects positioned lateral to both a driver's side and a passenger's side of a rear portion of the vehicle.

FIG. 8 is a perspective view of the lateral-view mirror assembly of FIG. 7, showing the head of the driver and the mirror assembly without the vehicle to illustrate how the driver views objects positioned lateral to both a driver's side and a passenger's side of a rear portion of the vehicle.

FIG. 9 is a perspective view of a bidirectional lateral-view mirror of the present invention.

FIG. 10 is a top view of the bidirectional lateral-view mirror of FIG. 9.

FIG. 11 is a bottom view of the bidirectional lateral-view mirror of FIG. 9, showing two adhesive squares.

FIG. 12 is a front view of the bidirectional lateral-view mirror coupled to a base.

FIG. 13 is a top view of another embodiment of the lateral-view mirror assembly of the present invention, showing a first lateral-view mirror and a second lateral-view mirror positioned in a line of sight with the rear-view mirror and dimensioned to allow a driver to view objects positioned lateral to both a driver's side and a passenger's side of a rear portion of the vehicle.

FIG. 14 is a perspective view of a lateral-view mirror of FIG. 13.

FIG. 15 is a perspective view of another embodiment of the lateral-view mirror assembly of the present invention, showing a first lateral-view mirror and a second lateral view mirror capable of being coupled to a portion of a rear window of a rear portion of a vehicle and positioned in a line of sight with a rear-view mirror.

FIG. 16 is a top view of the lateral view mirror of FIG. 15.

### DETAILED DESCRIPTION OF THE PREFERRED EMBODIMENTS

Referring to FIG. 1, reference number 10 refers generally to one embodiment of the lateral-view mirror assembly for a vehicle of the present invention. The lateral-view mirror assembly 10 includes, in this embodiment, at least one lateral-view mirror 14 (shown in FIGS. 1, 3-5) positioned on a rear, side portion of a vehicle 12. As shown in FIG. 1, the lateral-view mirror 14 is coupled to a rear driver's side portion of the vehicle 12 and dimensioned to allow a driver 16 to view objects positioned lateral to a driver's side of a rear portion 18 of the vehicle 12. Preferably, this is accomplished by the driver looking at his or her side-view mirror 24, with the lateral-view mirror 14 being positioned so that an object lateral to the rear of the vehicle 12 on the driver's side will be reflected by the lateral-view mirror 14 to the side-view mirror 24 and then viewable by the driver 16—as shown in FIG. 1. (It would also be possible, although less desirable, for the driver to simply look out the window directly at the lateral-view mirror 14, and to view lateral objects in this manner.)

The lateral-view mirror 14 may be integrally coupled to the vehicle 12 during the manufacturing stage or, alternatively, coupled to the rear side portion of the vehicle 12 after manufacture with a suitable adhesive 20 (shown in FIGS. 4-5). The adhesive 20 will have a gripping side 22 dimensioned to be coupled to the side rear side portion of the vehicle 12.

Referring now to FIGS. 2 and 6, a top view of the lateral-view mirror assembly 10 is shown. Observable in this view is a second lateral-view mirror 14, which should be positioned within a line of sight with a passenger's side side-view mirror 26—so as to permit the driver 16 to view lateral objects on the passenger side of the vehicle through the side-view mirror 26.

When viewing objects positioned on the passenger side of the vehicle 12, it may be necessary to modify the side-view mirror 26. Referring now to FIGS. 6 and 6A, a substantially flat mirror 28 is shown. The purpose of the substantially flat mirror 28 is to compensate for the convex nature of most passenger's side side-view mirrors 26. The convexity of a passenger's side side-view mirror 26 can distort the reflection of objects from the passenger's side lateral-view mirror 14. The substantially flat mirror 28, the driver's side side-view mirror 24, the side lateral-view mirrors 14, and the passenger's side side-view mirror 26 can be coupled to their respective areas with an adhesive or at the manufacturing stage as described in the lateral-view mirror assembly 10.

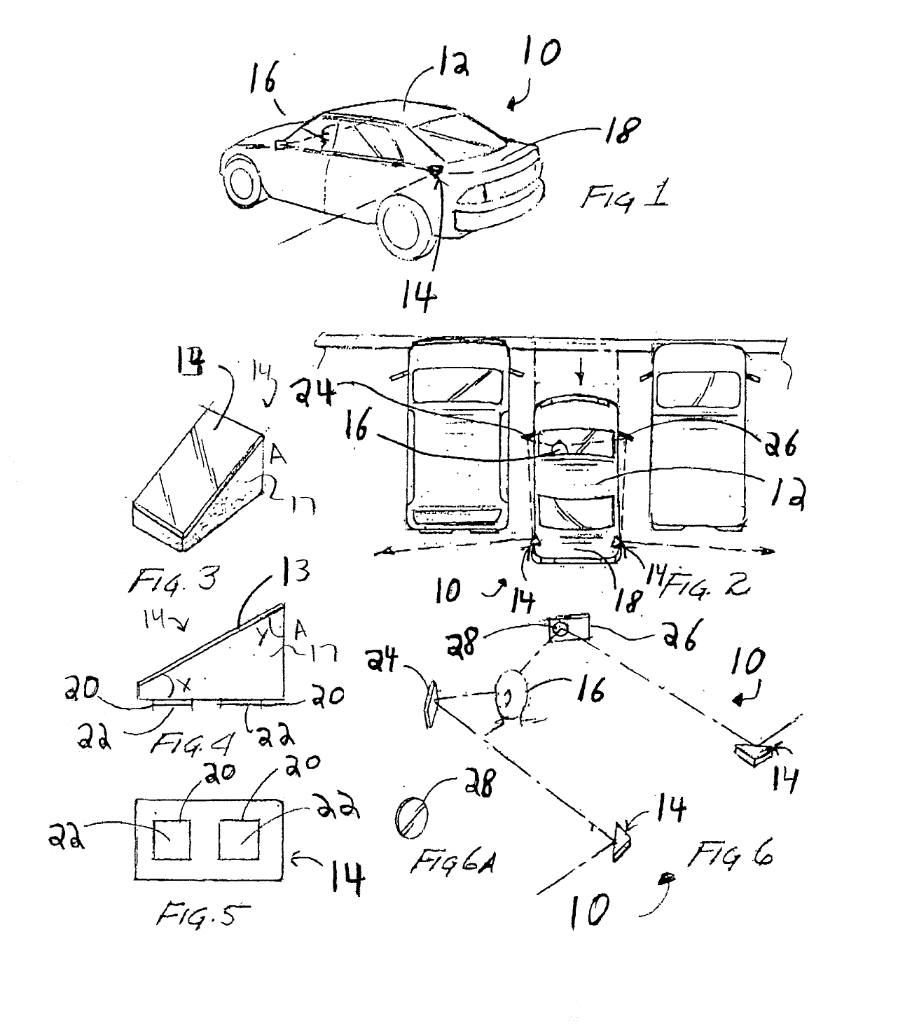

Referring now to FIGS. 3 and 4, it is preferred that each of the mirrors 14 comprise a mirror surface 13 positioned on a right triangle shaped base 17. The base 17 should be positioned on the vehicle 12 so that the adhesive 20 contacts the vehicle 12 and so that side A of the base 17 is most distal from the front of the vehicle 12. Preferably, angle X in base 17 should be approximately 30 degrees, and angle Y should be approximately 60 degrees.

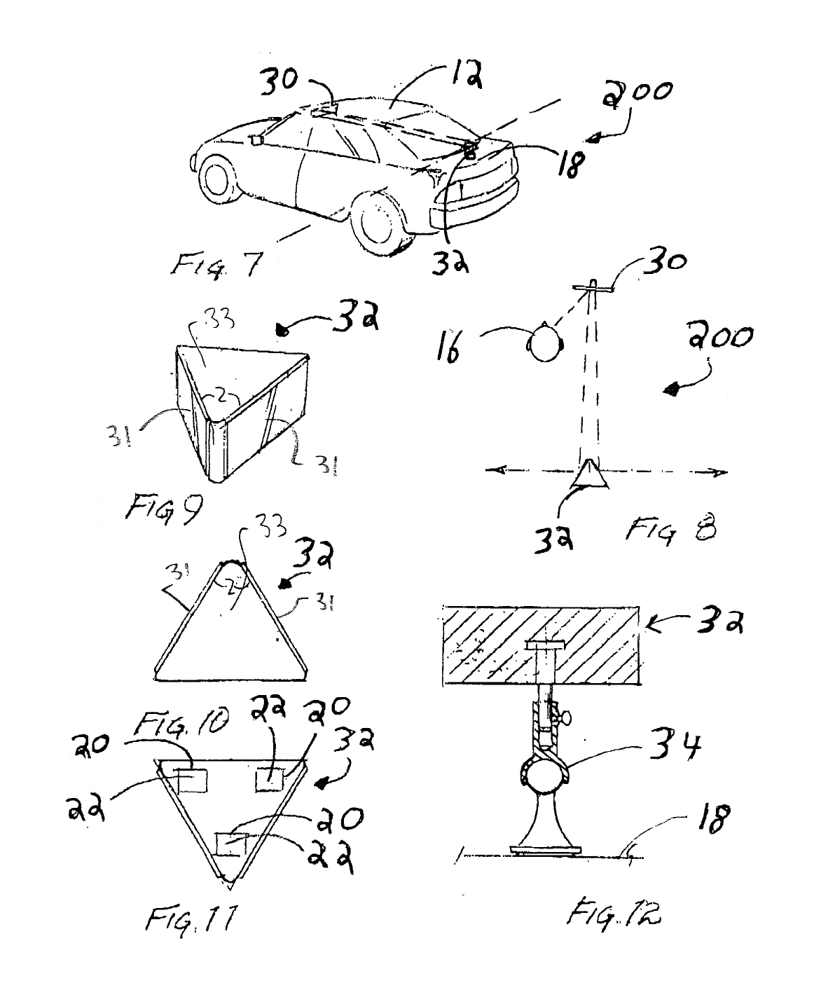

Referring now to FIGS. 7 and 8, an alternative embodiment of the lateral-view mirror assembly, hereinafter lateral-view mirror assembly 200, is shown. The lateral-view mirror assembly 200 uses a rear-view mirror 30 and a bidirectional lateral-view mirror 32 (shown in FIGS. 7-12) to provide a driver 16 with lateral vision rearward of the vehicle 12. The lateral-view mirror assembly 200 comprises a rear-view mirror 30 coupled to a front interior portion of a vehicle 12 and dimensioned to allow a driver 16 (shown in FIG. 8) to view objects positioned behind and lateral of the vehicle 12. The lateral-view mirror assembly 200 further comprises a bidirectional lateral-view mirror 32 (shown in FIGS. 7-12) coupled to a center portion of a rear portion 18 of a top surface of the vehicle 12.

The bidirectional lateral-view mirror 32 is positioned in a line of sight with the rear-view mirror 30 and is dimensioned to allow a driver 16 to view objects positioned lateral to both a driver's side of a rear portion 18 of the vehicle 12 and lateral to a passenger's side of a rear portion 18 of the vehicle 12 by looking at a reflection of the objects reflected from the bidirectional lateral-view mirror 32 to the rear-view mirror 30 to the driver 16.

Referring now to FIG. 12, preferably the lateral-view mirror assembly 200 further comprises a base 34 coupled to the bidirectional lateral-view mirror 32 and dimensioned to permit rotation of the bidirectional lateral-view mirror 32 and vertical adjustment of the bidirectional lateral-view mirror 32—so that it may be optimally positioned for a particular driver 16. While, in the preferred embodiment, the lateral-view mirror assembly 200 comprises a base 34, it should be clearly understood that substantial benefit could be derived from an alternative configuration of the lateral-view mirror assembly 200 which either lacks a base 34 or which has a base 34 which can only rotate or only adjust vertically the bidirectional lateral-view mirror 32.

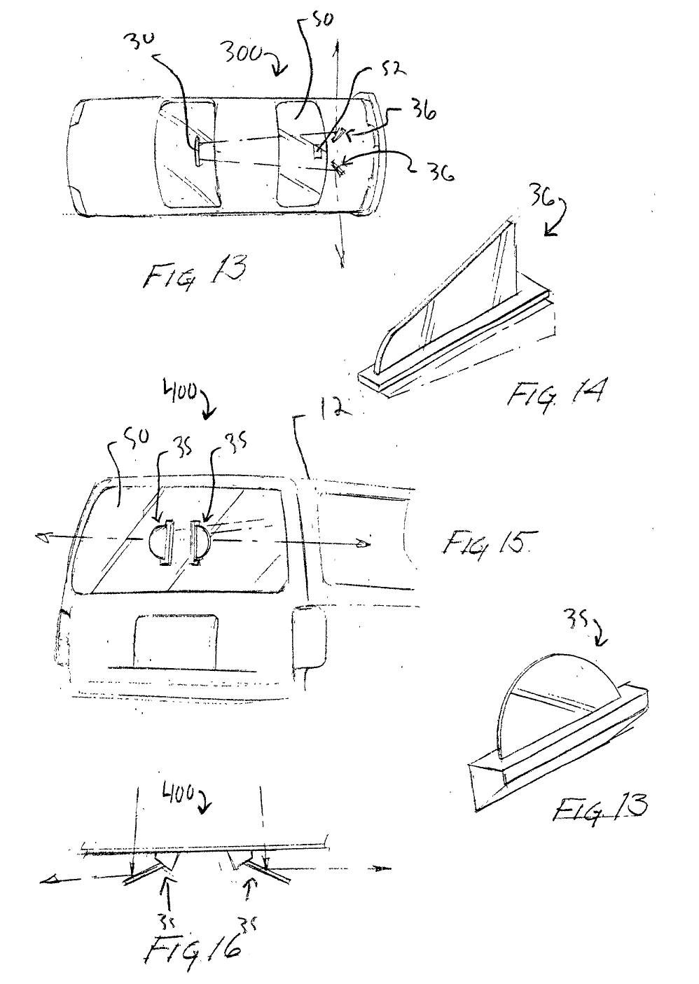

The bidirectional lateral-view mirror 32 or the base 34 with the lateral-view mirror 32 positional thereon should be coupled to a center portion of the top surface of the rear portion 18 of the vehicle 12 with an adhesive 20 (shown in FIG. 11) or at the manufacturing stage in a more permanent manner.

Referring now to FIGS. 9 and 10, it is preferred that lateral-view mirror 32 comprise two slightly convex mirror surfaces 31 positioned on a triangle shaped base 33. Internal angle Z in the base 33 should be approximately 30 degrees.

Referring now to FIGS. 13 and 14, an alternative embodiment of the lateral-view mirror assembly, hereinafter lateral-view mirror assembly 300, is shown. The lateral-view mirror assembly 300 is intended for use with those vehicles 12 having a rear window 50 that is obstructed in a center rear portion thereof by a third brake light 52, which third brake light 52 would block a driver 16's view of a center-positioned lateral-view mirror 32. Thus, in place of a single bidirectional lateral-view mirror 32, the lateral-view mirror assembly 300 uses first and second lateral-view mirrors 36 positioned on either side of the third brake light 52. The first lateral-view mirror 36 is positioned in a line of sight with the rear-view mirror 30 and is dimensioned to allow a driver 16 to view objects positioned lateral to the driver's side of a rear portion 18 of the vehicle 12 by looking at a reflection of the objects reflected from the first lateral-view mirror 36 to the rear-view mirror 30 to the driver 16. The second lateral-view mirror 36 is positioned in a line of sight with the rear-view mirror 30 and is dimensioned to allow a driver 16 to view objects positioned lateral to a passenger's side of a rear portion 18 of the vehicle 12 by looking at a reflection of the objects reflected from the second lateral-view mirror 36 to the rear-view mirror 30 to the driver 16.

The first and second lateral-view mirrors 36 can be coupled to the top surface of the rear portion 18 of the vehicle 12 with an adhesive 20 or at the manufacturing stage as described above.

Referring now to FIG. 15, an alternative embodiment of the lateral-view mirror assembly, hereinafter lateral-view mirror assembly 400, is shown. The lateral-view mirror assembly 400 is intended for use with vans and the like where the rear window is substantially vertical and where there is no rear portion of the vehicle 12 to which a bi-directional lateral view mirror 32 or lateral view mirrors 36 and 38 may be attached. In this kind of vehicle 12, first and second lateral-view mirrors 35 are coupled to a rear window in a line of sight with the rear-view mirror 30 and dimensioned to allow a driver 16 to view objects positioned lateral to both a driver's side of a rear end of the vehicle 12 and lateral to a passenger's side of a rear end of the vehicle 12 by looking at a reflection of the objects reflected from the lateral-view mirrors 35 to the rear-view mirror 30 to the driver 16.

The bidirectional lateral-view mirror 35 can be coupled to the rear window of the vehicle 12 with an adhesive 20 or at the manufacturing stage as described in the lateral-view mirror assembly 10. As shown in FIGS. 13 and 16, base portions 37 of the lateral-view mirrors 35 should be angled so as to provide proper positioning of the mirrors 35 to permit lateral viewing by the driver 16.

While the invention has been particularly shown and described with reference to preferred embodiments thereof, it will be understood by those skilled in the art that the foregoing and other changes in form and details may be made therein without departing from the spirit and scope of the invention. For example, while the use of mirrors has been discussed to provide a vehicle driver with a rear, lateral view, such a view could be provided with other means. For example, it would be possible to position one or more cameras on a rear portion of the vehicle, with the cameras positioned to capture an image of the vehicle's rear, lateral area. That image could be transmitted to the driver of the vehicle and displayed on a screen within the vehicle, or perhaps on a screen incorporated into a vehicle mirror. Such a means is intended to be within the scope of this invention.

I claim:

1. A lateral-view mirror assembly for a vehicle comprising, in combination:
a vehicle; and
at least one lateral-view mirror coupled to one of a rear portion and a rear window of said vehicle in line of sight with at least one of a side mirror of said vehicle and a rear-view mirror of said vehicle and dimensioned to allow a driver to view objects positioned lateral to a rear portion of said vehicle by looking at one of said side mirror and said rear-view mirror and seeing a reflection of said objects through said lateral-view mirror.

2. The assembly of claim 1 wherein said at least one lateral-view mirror is coupled to said driver's side rear side portion of said vehicle.

3. The assembly of claim 2 further comprising a second lateral-view mirror coupled to a passenger side of said vehicle proximate said rear portion of said vehicle in line of sight with a side mirror of said vehicle on said passenger side.

4. The assembly of claim 3 further comprising a substantially flat mirror adapted to be coupled to a surface of said side mirror on said passenger side of said vehicle.

5. The assembly of claim 1 wherein said at least one lateral-view mirror is adapted to be coupled to a center portion of a top surface of a rear portion of said vehicle, said lateral-view mirror is positioned in a line of sight with said rear-view mirror, said lateral-view mirror is dimensioned to allow a driver to view objects positioned lateral to one of a driver's side of a rear portion of said vehicle and lateral to a passenger's side of a rear portion of said vehicle by looking in a rear-view mirror within said vehicle at a reflection of said objects reflected from said lateral-view mirror.

6. The assembly of claim 5 wherein said lateral-view mirror is dimensioned to allow a driver to selectively view objects positioned lateral to either of a driver's side of a rear portion of said vehicle and lateral to a passenger's side of a rear portion of said vehicle by looking in a rear-view mirror within said vehicle at a reflection of said objects reflected from said lateral-view mirror.

7. The assembly of claim 5 further comprising a base coupled at a first end to said vehicle and at a second end to said lateral-view mirror and dimensioned to permit vertical movement of said lateral-view mirror.

8. The assembly of claim 4 further comprising a base coupled at a first end to said vehicle and at a second end to said lateral-view mirror and dimensioned to permit rotational movement of said lateral-view mirror about a horizontal axis.

9. The assembly of claim 7 wherein said base is further dimensioned to permit rotational movement of said lateral-view mirror about a horizontal axis.

10. The assembly of claim 1 wherein said at least one lateral-view mirror comprises a first lateral-view mirror coupled to a top surface of a rear portion of said vehicle between a center portion of said top surface and a driver's side of said top surface, said first lateral-view mirror is positioned in a line of sight with said rear-view mirror, said first lateral-view mirror is dimensioned to allow a driver to view objects positioned lateral to said driver's side of a rear portion of said vehicle by looking at a reflection of said objects reflected from said first lateral-view mirror to said rear-view mirror to said driver; and
a second lateral-view mirror distant from said first lateral-view mirror and coupled to a top surface of a rear portion of said vehicle between a center portion of said top surface and a passenger's side of said top surface, said second lateral-view mirror is positioned in a line of sight with said rear-view mirror, said second lateral-view mirror is dimensioned to allow a driver to view objects positioned lateral to a passenger's side of a rear portion of said vehicle by looking at a reflection of said objects reflected from said second lateral-view mirror to said rear-view mirror to said driver.

11. The assembly of claim 1 wherein said at least one lateral-view mirror comprises a first lateral-view mirror coupled to a rear window of said vehicle between a center portion of said rear window and a driver's side of said rear window, said first lateral-view mirror is positioned in a line of sight with said rear-view mirror, said first lateral-view mirror is dimensioned to allow a driver to view objects positioned lateral to said driver's side of a rear portion of said vehicle by looking at a reflection of said objects reflected from said first lateral-view mirror to said rear-view mirror to said driver; and
a second lateral-view mirror distant from said first lateral-view mirror and coupled to said rear window of said vehicle between said center portion of said rear window and a passenger's side of said rear window, said second lateral-view mirror is positioned in a line of sight with said rear-view mirror, said second lateral-view mirror is dimensioned to allow a driver to view objects positioned lateral to a passenger's side of a rear portion of said vehicle by looking at a reflection of said objects reflected from said second lateral-view mirror to said rear-view mirror to said driver.

12. A lateral-view mirror assembly for a vehicle comprising, in combination:
a vehicle; and
at least one lateral-view mirror coupled to a side rear portion of said vehicle in line of sight with a side mirror of said vehicle and dimensioned to allow a driver to view objects positioned lateral to a rear portion of said vehicle by looking at said side mirror and seeing a reflection of said objects through said lateral-view mirror.

13. The assembly of claim 12 wherein said at least one lateral-view mirror is coupled to said driver's side rear side portion of said vehicle.

14. The assembly of claim 13 further comprising a second lateral-view mirror coupled to a passenger side of said vehicle proximate said rear portion of said vehicle in line of sight with a side mirror of said vehicle on said passenger side.

15. The assembly of claim 14 further comprising a substantially flat mirror adapted to be coupled to a surface of said side mirror on said passenger side of said vehicle.

16. A lateral-view mirror assembly for a vehicle comprising, in combination:
a vehicle; and
at least one lateral-view mirror coupled to a top rear portion of said vehicle in line of sight with a rear-view mirror of said vehicle and dimensioned to allow a driver to view objects positioned lateral to a rear portion of said vehicle by looking at said rear-view mirror and seeing a reflection of said objects through said lateral-view mirror.

17. The assembly of claim 16 wherein said lateral-view mirror is dimensioned to allow a driver to selectively view objects positioned lateral to either of a driver's side of a rear portion of said vehicle and lateral to a passenger's side of a rear portion of said vehicle by looking in a rear-view mirror within said vehicle at a reflection of said objects reflected from said lateral-view mirror.

18. The assembly of claim 16 further comprising a base coupled at a first end to said vehicle and at a second end to said lateral-view mirror and dimensioned to permit vertical movement of said lateral-view mirror.

19. The assembly of claim 18 wherein said base is further dimensioned to permit rotational movement of said lateral-view mirror about a horizontal axis.

20. A lateral-view assembly for a vehicle comprising, in combination:
a vehicle; and
means for capturing an image of an area rearward of and lateral to said vehicle and displaying said image to a driver of said vehicle.
